(19) United States
(12) Patent Application Publication
(10) Pub. No.: US 2008/0228782 A1
(43) Pub. Date: Sep. 18, 2008

(54) Apparatus, Method, and Computer Program Product for Creating Hierarchical Dictionary

(76) Inventors: Hiroshi Murayama, Kanagawa (JP); Noriko Minamino, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/586,477

(22) PCT Filed: Apr. 26, 2006
(86) PCT No.: PCT/JP2006/309186

§ 371 Date: Jul. 18, 2006

(30) Foreign Application Priority Data
Sep. 22, 2005 (JP) 2005-276647

(51) Int. Cl. G06F 17/30

(52) U.S. Cl. 707/100; 707/E17.005

(57) ABSTRACT

A hierarchical dictionary creating apparatus includes an operation file editing unit that edits a logic operation file by adding a new class using an inter-class logic operation, the logic operation file in which the inter-class logic operation is described, the inter-class logic operation being employed in a hierarchical dictionary having inheritance of a property from an upper class to a lower class; an operation file storing unit that stores the logic operation file edited by the operation file editing unit; an operation file determining unit that determines a property to be introduced from an existing class to the new class in the logic operation file stored in the operation file storing unit; a dictionary file outputting unit that outputs the property to be introduced from the existing class to the new class into a hierarchical dictionary file, the property being determined by the operation file determining unit; and a dictionary file storing unit that stores the hierarchical dictionary file.

### TECHNICAL FIELD

The present invention relates to a hierarchical dictionary creating apparatus, a computer program product, and a method that are used for description and creation of a hierarchical dictionary having a function of inheriting properties from upper classes to lower classes, in compliance with XML schema, Resource Description Framework (RDF), ISO13584/IEC61360, ISO15926 standard, or the like.

This application is based upon and claims the benefit of priority from the prior Japanese Patent Application No. 2005-276647, filed on Sep. 22, 2005; the entire contents of which are incorporated herein by reference.

### BACKGROUND ART

A hierarchical database, which is exemplified by an object-oriented database (OODB) and an object relational database (ORDB), has a hierarchical structure in which lower classes inherit properties of upper classes. In such a hierarchical database, the number of properties of the lower classes increases with successions from the upper classes. The successions of the properties of the upper classes to the lower classes are generally called “inheritance,” the feature of which is described in many documents.

In the OODB, a unit of classification of one level is generally called a “class.” On the other hand, in the ORDB, a table that permits the inheritance corresponds to the class in the OODB. Between the tables with a hierarchical relation, the properties are inherited from upper tables to lower tables, in other words, header information of a column constituting an upper table is inherited to a lower table. Data having the same type of property and belonging to a certain class of each level is called an “instance,” and a collection thereof is called a “population.” The population of data is usually stored in a structure called table in a relational database (RDB) or an ORDB. A string of properties making up a table is called a header of the table.

One known hierarchical database is defined by ISO13584 Parts Library Standard (hereinbelow simply referred to as “PLIB” standard), which is an international standard for implementing an electronic catalogue system which electronically providing product information. The “PLIB” standard is an international standard consisting of a plurality of “Parts” and defines a manner of object-oriented description of products library data or parts library data and a semantics for file exchange, in other words, defines what kind of terms, manner of description, and data type are to be employed. Part 42 (Part Issue No. 42) of the PLIB has same contents with the IEC61360-2 (Part Issue No. 2). The standard classifies products in an object-oriented manner, clarifies a group of properties characterizing each class, and realizes a file exchange of the contents corresponding to the class, and therefore, the concept of property inheritance is naturally incorporated herein. Further, since the standard is formulated based on the ISO6523 “Structure for Identification of organizations and organization parts,” with the use of the International Code Designator (ICD) defined by ISO 6523, in particular, an internationally unique identifier can be allocated to each property.

In recent years, systems based on the PLIB standard are proposed, for example, in Japanese Patent Application Laid-Open No. 2004-177996, and Japanese Patent Application Laid-Open No. 2004-178015.

According to the above described PLIB standard, a dictionary in which the property inheritances and imports among classes are described in detail is created in advance.

### DISCLOSURE OF INVENTION

However, it is troublesome and time-consuming to create such a dictionary in which the property inheritances and imports among classes are described in detail. Also, users need to grasp the specific rules and methods concerning the description of inheritances and the import of each property. Further, there is an increase in the amount of descriptions concerning the property imports in the data dictionary.

According to one aspect of the present invention, a hierarchical dictionary creating apparatus includes an operation file editing unit that edits a logic operation file by adding a new class using an inter-class logic operation, the logic operation file in which the inter-class logic operation is described, the inter-class logic operation being employed in a hierarchical dictionary having inheritance of a property from an upper class to a lower class; an operation file storing unit that stores the logic operation file edited by the operation file editing unit; an operation file determining unit that determines a property to be introduced from an existing class to the new class in the logic operation file stored in the operation file storing unit; a dictionary file outputting unit that outputs the property to be introduced from the existing class to the new class into a hierarchical dictionary file, the property being determined by the operation file determining unit; and a dictionary file storing unit that stores the hierarchical dictionary file.

According to another aspect of the present invention, a method of creating a hierarchical dictionary includes editing a logic operation file by adding a new class using an inter-class logic operation, the logic operation file in which the inter-class logic operation is described, the inter-class logic operation being employed in a hierarchical dictionary having inheritance of a property from an upper class to a lower class; storing the edited logic operation file; determining a property to be introduced from an existing class to the new class in the logic operation file; converting the property to be introduced from the existing class to the new class into a hierarchical dictionary file, the property being determined; and storing the hierarchical dictionary file.

A computer program product according to still another aspect of the present invention causes a computer to perform the method according to the present invention.

### BRIEF DESCRIPTION OF DRAWINGS

FIG. 1 shows an exemplary structure of a hierarchical dictionary that is the basis of embodiments of the present invention;

FIG. 2 shows an exemplary structure of a hierarchical dictionary utilizing a simple tree based on the PLIB standard;

FIG. 3 shows an example of dictionary revising rules related to a class;

FIG. 4 shows an example of the dictionary revising rules related to a property;

FIG. 5 is a schematic diagram of an exemplary structure of a system including a hierarchical dictionary creating apparatus according to a first embodiment of the present invention;

FIG. 6 is a diagram of a module structure of a server;

FIG. 7 is a block diagram of a schematic structure of the server;

FIG. 8 shows an example of a logic operator tree;

FIG. 9 shows an example of description in an inter-class logic operation file according to Recording Method 1;

FIG. 10 shows an example of description in the inter-class logic operation file according to Recording Method 2;

FIG. 11 shows an example of an actual Graphical User Interface (GUI) for instructing an inter-class Boolean operation;

FIG. 12 shows an example of an actual GUI for generating a result of an operation as a lower class of one operator;

FIG. 13 shows an example of the actual GUI in which an operand class is clearly distinguished from the other classes;

FIG. 14 shows another example of the actual GUI in which the operand class is clearly distinguished from the other classes;

FIG. 15 shows an example of a result of an inter-class product operation;

FIG. 16 shows an example where a composite class is created below a root;

FIG. 17 shows an example where an intermediate class is created below the root;

FIG. 18 shows an example where the GUI contains class information and a property list;

FIG. 19 shows an example where a state after a Join operation is displayed;

FIG. 20 shows an exemplary display of a result of tentative combination;

FIG. 21 shows an example of a derivative property that is created after a test;

FIG. 22 shows an example of a relation between a derivative property and a parent property (super property) shown in FIG. 21;

FIG. 23 shows an example of duplicating properties where definitions of a property A and a property B are changed at the same time;

FIG. 24 shows an example of a relation between a parent property (super property) and derivative properties shown in FIG. 23;

FIG. 25 shows an example of the GUI in which a new class is generated through product set operations among three classes;

FIG. 26 shows an example of a result of product operations among the three classes;

FIG. 27 shows an example of a hierarchical structure according to a second embodiment of the present invention;

FIG. 28 shows an example of a content table of each class and a search result;

FIG. 29 shows an example of description of relations between original identifiers and derivative identifiers;

FIG. 30 shows an exemplary display on a search condition setting screen for a class “C012; Two-Wheeled Motor Vehicles”;

FIG. 31 shows an example of a hierarchical structure according to a third embodiment of the present invention;

FIG. 32 shows an example of a content table of a class “C011: Motor Vehicles”;

FIG. 33 shows an example of a content table of a class “C091: Tires”;

FIG. 34 shows an example of a result of a Join operation performed between the content tables of FIGS. 32 and 33;

FIG. 35 shows an example where a new-class is created as a lower class of one of the classes to which a calculated content table belongs;

FIG. 36 shows information of derivative properties;

FIG. 37 shows an example of description of derivative relations in EXPRESS, using the Part 21 format;

FIG. 38 shows an example where a new class is created at a completely different location from two original classes, and new derivative identifiers are allotted to both of the duplicating properties; and

FIG. 39 shows information of derivative properties.

### BEST MODE(S) FOR CARRYING OUT THE INVENTION

The following is a description of preferred embodiments of a hierarchical dictionary creating apparatus, a computer program product for hierarchical dictionary creation, and a hierarchical dictionary creating method in accordance with the present invention, with reference to the accompanying drawings.

### 1. Hierarchical Dictionary

A hierarchical dictionary employed in an electronic catalogue system that electronically provides product information will be first described. The hierarchical dictionary is a basis for embodiments.

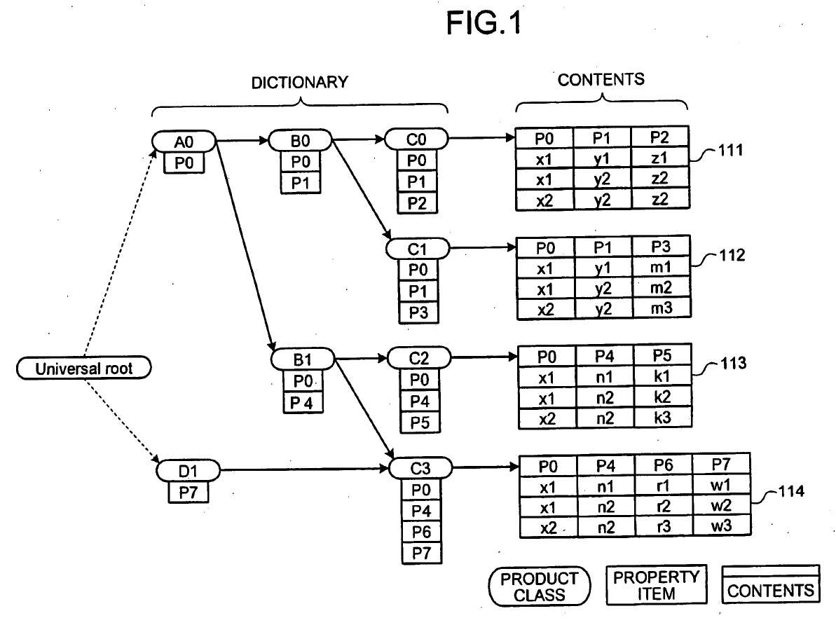

FIG. 1 shows an exemplary structure of a hierarchical dictionary. The hierarchical dictionary shown in FIG. 1 is a hierarchical database divided into plural levels. Each level has one or more classification items, and lower levels inherit properties of upper levels. Hence, the properties of the classification items in a lower level succeed the properties of the classification items in an upper level. Here, each of the hierarchical classification items is called class, and each class has its own properties. The hierarchical dictionary shown in FIG. 1 indicates a general inter-class property inheriting relation including a multiple inheritance. The classes are represented by A0, B0, B1, C0, C1, C2, C3, and D1, whereas the properties are represented by P0 to P7. The class C3 inherits the properties P0 and P4 from the parent class B1, while inheriting the property P7 from another parent class D1. The property P6 is uniquely defined in the class C3. The class A0 and the class D1 are independent classes. A universal root is an overarching class which hypothetically includes all root classes. The universal root may correspond to what is generally called a “universal set” in mathematics. Since the overarching class has no unique property and no property to be inherited, the overarching class can be treated as a parent class of any root class.

PLIB standard (ISO13584 Parts Library), which is an international standard for implementing an electronic catalogue system that electronically provides product information, employs a simple tree structure as a hierarchical structure for classification of products and properties thereof. Hence, there is only one upper class (parent class). When the property of class other than the parent class is to be inherited, a special structure is employed for an import (citation) of a property called “Case Of.” This structure can be regarded as a modified version of the multiple inheritance of FIG. 1, in other words, a structure in which a tree is divided into a main line and a sub-line, the main line being formed from a parent class with a smallest number and the sub-line being given an alternate name “Case Of.” In the ORDB or a general object-oriented database, not all the tables and classes have a parent table or a parent class. However, the table and the class which exists independently can be connected to a hypothetical “universal root” as shown in FIG. 1, so that all classes can be traced back to a single root, the feature of which can be similarly found in the simple tree structure.

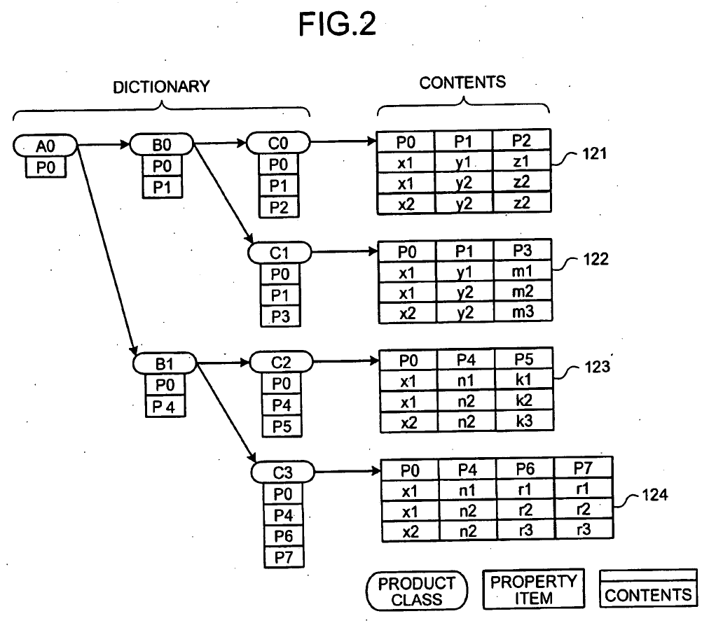

FIG. 2 shows an exemplary structure of a hierarchical dictionary employing a simple tree structure based on the PLIB standard. The hierarchical dictionary shown in FIG. 2 based on the PLIB standard does not have a universal root. In FIG. 2, a portion including A0, B0, B1, C0, C1, C2, and C3 of the tree structure represents information including classification levels. In the embodiment, the tree is a simple tree, and the class has only one upper class.

In FIG. 2, the class A0 has lower classes B0 and B1. The class B0 has lower classes C0 and C1, whereas the class B1 has lower classes C2 and C3. Each product class has a property item and the property of an upper class is inherited to a lower class. In FIG. 2, contents 121, 122, 123, and 124 are actual product data. For example, the content 121 is product data of the C0. The content 121 includes content data of three types. More specifically, the content 121 includes property values x1 and x2 of a property item P0, property values y1 and y2 of a property item P1, and property values z1 and z2 of a property item P2.

The contents 111 to 114 of FIG. 1 have similar characteristics with contents 121 to 124 of FIG. 2.

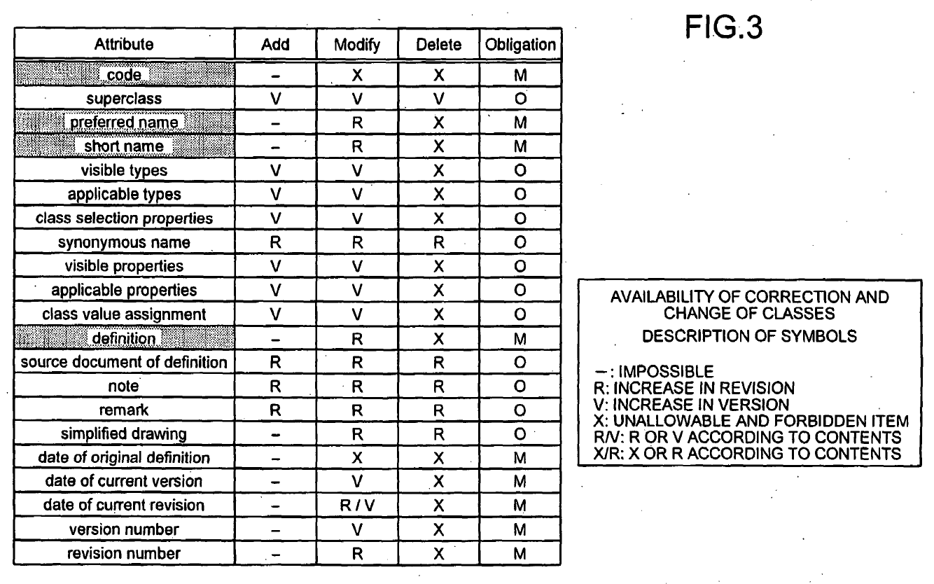

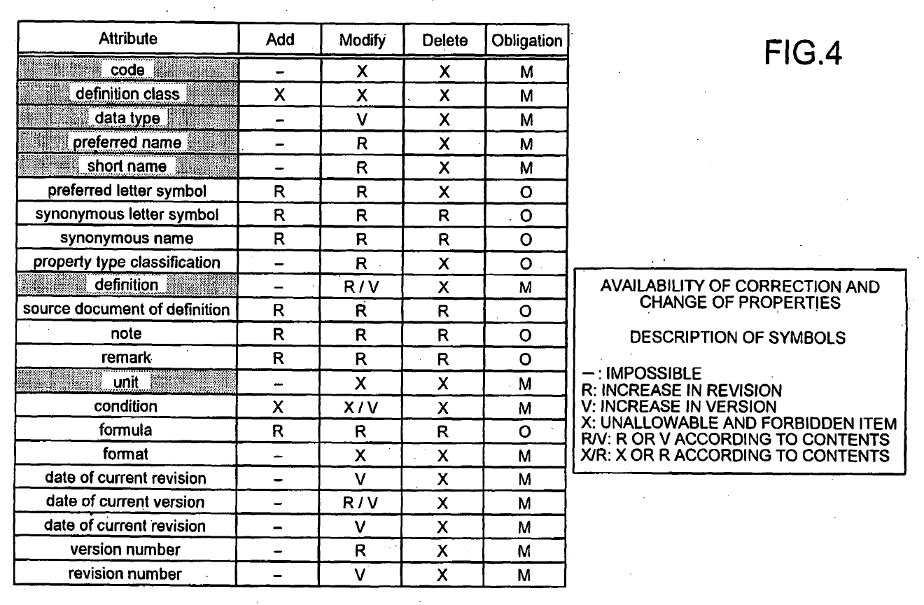

The class and the property of the dictionary are defined by respective attributes. Here, “attribute” means an information field employed to define detailed information of each class and property. To avoid confusion between the “property” of the class and the “attribute,” the detailed information fields of the class and the property will be referred to as the “attribute” in the description. For each class, as shown in FIG. 3, attributes such as a class type (class type), a class name (code), a parent class (superclass), and a standard name (preferred name) are defined. For a property, as shown in FIG. 4, attributes such as a property code (code), a definition class (definition class), a data type (data type), and a standard name (preferred name) are defined.

The attributes define the class and the property based on the PLIB definition thereby determining a format of the content, whether the content can be edited or not (as indicated by “Add,” “Modify,” and “Delete” in FIGS. 3 and 4), whether the content is mandatory or optional (as indicated by “Obligation” in FIGS. 3 and 4), or the like.

### 2. System Structure

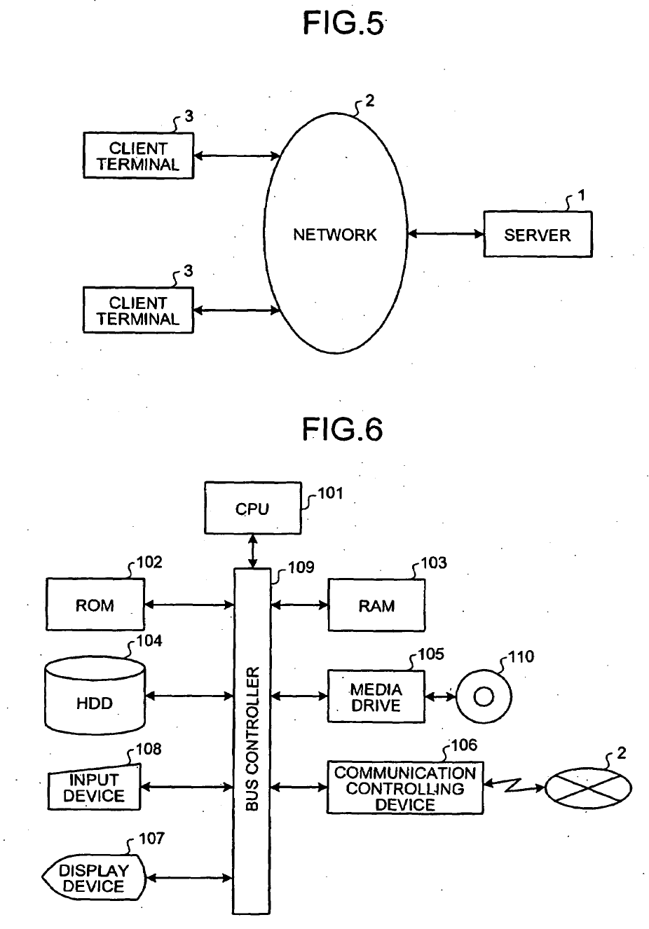

A first embodiment of the preset invention will be described in detail. FIG. 5 is a schematic diagram of an example of a structure of a system including a hierarchical dictionary creating apparatus according to the first embodiment. The system, as shown in FIG. 5, is assumed to be a server-client system where a server computer 1 (hereinafter simply referred to as a server) which is a hierarchical dictionary creating apparatus, is connected to plural client computers 3 (hereinafter simply referred to as client terminals) which are terminal devices via a network 2 such as a Local Area Network (LAN) or the like. The client terminal 3 is a general personal computer or the like.

FIG. 6 is a diagram of a module structure of the server 1. The server 1 includes a central processing unit (CPU) 101 which performs information processing, a read only memory (ROM) 102 which stores BIOS or the like and is a dedicated memory for reading out, a random access memory (RAM) 103 which rewritably stores various data, a hard disk drive (HDD) 104 which functions as various databases and stores various programs, a media drive 105, such as a CD-ROM drive, which serves to store information, externally distribute information, and externally acquire information, using a storing medium 110, a communication controlling device 106 that serves to transmit information to/from other external computer via the network 2, a display device 107 such as a cathode ray tube (CRT), or a liquid crystal display (LCD) that displays information such as condition of processing and results of processing to an operator, and an input device 108, such as a keyboard or a mouse, which serves to receive input such as a command or information from the operator to supply the same to the CPU 101, and the data transmitted among the respective units are arbitrated by a bus controller 109.

When the power of the server 1 is turned on by the user, the CPU 101 starts up a program called loader inside the ROM 102, to read out an operating system (OS) which is a program for managing a hardware and a software of the computer from the HDD 104 to the RAM 103, and starts up the OS. The OS serves to activate a program, read in information, and store information according to a manipulation by the user. Known typical OS are, for example, Windows (registered trademark), and UNIX (registered trademark). A program running on the OS is called an application program. The application program is not limited to those running on a predetermined OS and may be a program that let the OS execute a part of various processing described later. Still alternatively, the application program may be included in a group of program files making up a predetermined application software or an OS.

Here, the server 1 stores the hierarchical dictionary creating program in the HDD 104 as an application program. In this sense, the HDD 104 functions as a storing medium that stores the hierarchical dictionary creating program.

A program installed in the HDD 104 of the server 1 is generally recorded in the storing medium 110 such as an optical disk such as a CD-ROM, or a DVD, various magnetooptical disk, various magnetic disk such as a flexible disk, a media of various recording schemes such as a semiconductor memory, and the program stored in the storing medium 110 is installed into the HDD 104. Here, a portable storing medium 110 such as an optical information recording medium such as a CD-ROM, or a magnetic media such as an FD can be employed as a storing medium that stores a hierarchical dictionary creating program. Further, the hierarchical dictionary creating program may be taken in from outside via the communication controlling device 106, for example, and installed into the HDD 104.

When the hierarchical dictionary creating program running on the OS is started up, the server 1 follows the hierarchical dictionary creating program, and the CPU 101 executes various operations to collectively control the respective units. Among the various operations executed by the CPU 101 of the server 1, characteristic processing of the first embodiment will be described below.

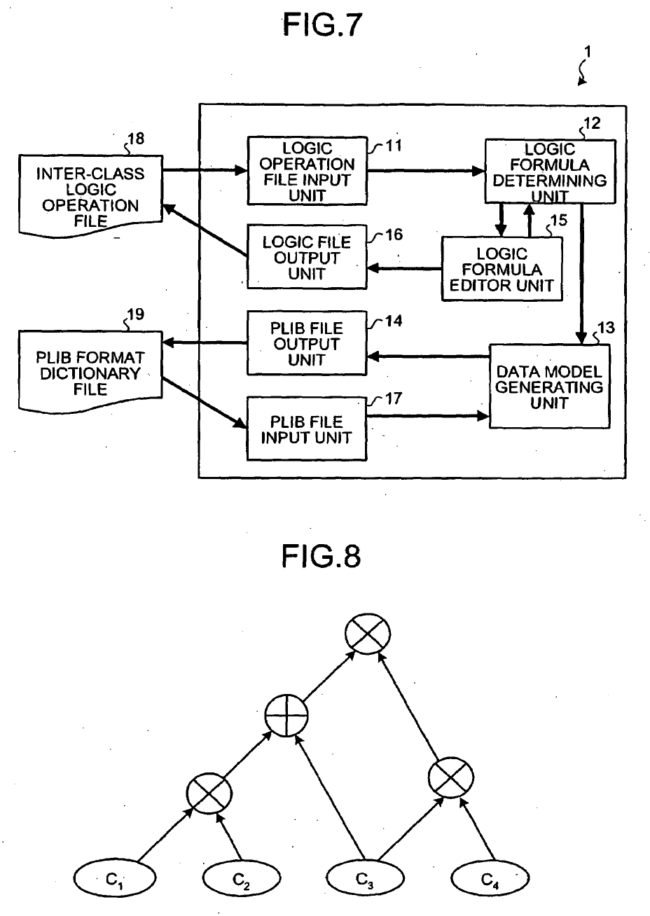

FIG. 7 is a block diagram of a schematic structure of the server 1. As shown in FIG. 7, according to the hierarchical dictionary creating program, the server 1 includes a logic operation file input unit 11, a logic formula evaluating unit 12 that functions as an operation file evaluator, a data model generating unit 13, a PLIB file output unit 14, a logic formula editor unit 15 that functions as an operation file editor, a logic file output unit 16, and a PLIB file input unit 17 that functions as a dictionary file input unit. A logic operation file 18 in which logic operations (Boolean operations) between classes are described, and a PLIB format dictionary file 19 that is a hierarchical dictionary file of a file format according to the PLIB standard (such as ISO10303-21 or a XML file representing the PLIB data model) are stored in the RAM 103 or the HDD 104 that are a storage unit. In the following, each of the functions is described.

The logic operation file input unit 11 reads in the inter-class logic operation file 18. After the reading-in, the inter-class logic operation file 18 is evaluated by the logic formula evaluating unit 12, and the evaluation results are output to the data model generating unit 13.

The data model generating unit 13 replaces the evaluation results from the logic formula evaluating unit 12 with a PLIB data model. The data model generated by the data model generating unit 13 is output in a PLIB file format (such as ISO10303-21 or a XML file representing the PLIB data model) from the PLIB file output unit 14, and is stored as the PLIB format dictionary file 19 in the RAM 103 or the HDD 104. In this manner, the function of the dictionary file storage unit is realized. The data model generating unit 13 and the PLIB file output unit 14 form the dictionary file output unit.

Meanwhile, the logic formula editor unit 15 edits the inter-class logic operation file 18, using a GUI (Graphical User Interface) that functions as a text or an editor unit. The inter-class logic formula file 18 edited by the logic formula editor unit 15 is output from the PLIB file output unit 14, and is stored in the RAM 103 or the HDD 104. In this manner, the function of the operation file storage unit is realized.

As described above, basically, the inter-class logic operation file 18 is converted so as to generate a new PLIB format dictionary file 19. Alternatively, an existing PLIB format dictionary file 19 is read by the PLIB file input unit 17, and is combined with the information recorded in the inter-class logic operation file 18 already evaluated by the logic formula evaluating unit 12. After the data model generating unit 13 combines the information as a new PLIB data model, the PLIB file output unit 14 outputs a new PLIB format dictionary file 19.

3. Logic Operation File in which Inter-class Logic Operations (Boolean Operations) are Described

Here, the logic operation file 18 in which inter-class logic operations (Boolean operations) are recorded is described in detail.

### 3-1. Property Combining by Inter-class Boolean Operation

First, the property combining by inter-class Boolean operations is described. In this embodiment, instead of the inheritance of properties based on the concept of upper and lower classes, and imports (also referred to as “partial inheritance”) of the respective properties according to “Case of”, a new class is defined by a Boolean operation between classes, and a property other than the properties to be inherited is imported.

According to Thomas Jeck, “Set Theory”, Springer Verlag 1997, in the case of mathematical classes, the inter-class Boolean operations are defined as follows. When C₁ represents class 1, and Φ₁ (x) represents property conditions that should be satisfied by the class 1, the product between the classes (intersection), the sum (union), and the difference (subtraction) are defined by the following expressions (1) through (3), respectively:

C₁∩C₂≡{x|Φ₁(x) [symbol] Φ₂(x)} (1)

C₁○C₂≡{x|Φ₁(x) [symbol] Φ₂(x)} (2)

C₁−C₂≡C₁∩ [symbol] C₂≡{x|Φ₁(x) [symbol] Φ₂(x)} (3)

Here, the property conditions of the class 1 are expressed as:

Φ₁(x)≡φ₁₁(x) [symbol] φ₁₂(x) [symbol] φ₁₃(x) . . . [symbol] φ₁ₖ(x)

which is a logic product of k constituent properties φ₁ⱼ(x) (1≦j≦k). Likewise, the property conditions of class 2 can be expressed by rewriting the expression (1) as the logic product of m constituent properties Φ₂ⱼ(x) (1≦j≦m):

C_{1∩C}₂≡{x|φ₁₁(x) [symbol] φ₁₂(x) [symbol] φ₁₃(x) . . . [symbol] φ₁ₖ(x) [symbol] φ₂₁(x) [symbol] φ₂₂(x) [symbol] φ₂₃(x) . . . φ₂ₘ(x)} (4)

The logic product of the class 1 and the class 2 is a class that has all the properties of the class 1 and all the properties of the class 2. Hence, all the properties of the other class can be imported through the inter-class Boolean product operation.

The linkage of the logic products of classes can be expressed as:

C₁∩C₂∩C₃≡[C₁∩C₂]∩C₃≡{x|Φ₁(x) [symbol] Φ₂(x) [symbol] Φ₃(x)} (5)

if the properties are independent of one another. When the operation is repeated for other classes, i.e., the class 2, the class 3, and the class 4, sequentially, a class having the properties of a desired number of classes can be generated.

The import of the properties of other classes through Boolean operations can be replaced with the concept of equivalent subclasses, if the logic formula is formed only with a simple product of classes. However, the two concepts are not always equivalent. In other words, a class obtained as a result of a difference operation is not always a subclass of a class, though a difference operation can be included in the description of Boolean formulas.

If a class obviously has instances, in other words, if a class has members, the class is considered to be equivalent to a set, and the Boolean operation is considered to be a set operation. In the inter-class Boolean operations described here, however, attention is focused on the property conditions of classes after the operation, and the operation should not be confused with formulation of set products, set sums, and set differences of members (tuples) in relational algebras that are the bases of SQL, which is widely used for databases. In a relational database, a set operation merely produces a common set, a sum set, and a difference set of the members (tuples) between tables having the same properties. A Join operation which is the only operation between tables having different properties is generally expressed as a direct product. More strictly, however, the Join operation involves an ordered pair of sets of properties contained in two tables. When the Join operation is performed on two tables Ta and Tb, the result will be <Ta, Tb> or <Tb, Ta> depending on the order of the operand tables, and the form of the resulting table is different depending on the order of the operand tables.

On the other hand, when a new class is generated by logical multiplication in the inter-class set operation, C_{1 ∩C}₂ and C₂∩C₁ are generally equal to each other. This is because the two are the combinations of the same properties.

In the set operation, the following relational expressions hold. Since the logic difference expressed as the negation (complement set) of each property in accordance with the expression (3), can be replaced with logic products, the following expressions hold:

C₁□C₁=C₁ (61)

C₁□C₂=C₂□C₁ (6-2)

*C₁□C₂)=C₁□(C₂□C₃) (6-3)

where “□” represents a logic product or a logic sum, and Cᵢ represents a class.

Also, the distributive law is satisfied between a logic product and a logic sum.

(C₁∩C₂)∩C₃=(C₁∩C₃)∪(C₂∩C₃) (7)

The new class can be defined as a lower class (in an object-oriented data modeling) of one or more classes of an existing dictionary. However, independent from the concept of property inheritance among classes in the object-oriented data modeling, the new class may be formed below the root of the class tree as a class in which the Boolean formula is recorded as a property of the new class. In such a case, the Boolean formula is performed on one or more classes whose property is to be imported.

Alternatively, the new class may be provided as an “application class” belonging to a different category from the class in the existing reference dictionary (hereinafter referred to as the “reference class”). In any case, the properties to be actually introduced from another class to the new class are determined at the time of evaluation of the Boolean formula recorded as the attribute of the new class, and differ from the direct property inheritance. relation with the simple and multiple inheritances between classes in the object-oriented data modeling.

In brief, it is not essential that all inter-class inheritance relation be described in the data dictionary, or that import information of each property be described in advance. It is sufficient that all the specifications of the properties be clear at the time of input of the instances with respect to the classes for which actual contents creation is performed. Accordingly, when data is actually created based on the data dictionary, or when a template is created for actual data input, the Boolean formulas recorded in the classes in the dictionary may be evaluated, and the properties to be introduced from the class referred to by the formulas in the existing dictionary are determined. The information of the properties is thus collected, and is converted into a data input format in which all the necessary information for data creation and input is combined. The resultant data are displayed and stored, and may be provided for the input of property value by the user. However, in a structure for describing Boolean algebras and logic formulas, or in a program language, logic symbols such as [symbol] , [symbol] , and [symbol] , are not provided (because they cannot easily be input through a keyboard). Therefore, to directly represent logic formulas as an information structure, it is necessary to record those symbols as character strings using the multiplication symbol (*), the addition symbol (+), and signs such as (−), instead of the above-mentioned symbols.

The import of properties based on the above-described inter-class Boolean operations, in other words, the import of the properties other than the properties to be inherited from the class immediately above the new class, is performed by conversion of each property into the importing format with the “Case of” defined by ISO13584, and output to a file. By doing so, a function that secures the compatibility between the dictionary and an external system that is compliant with ISO13584 can be provided. ISO13584 basically concerns simple inheritance involving only one parent class. In a case where a class C1 requires the properties of a class C3 that is not a parent class C2, the class 1 needs to be declared as the “Case of” of the class C3 in advance. When a dictionary compliant with ISO 13584 is created through inter-class logic operations according to the present invention, all the properties that are not inherited from the upper class are regarded as being imported using the “Case of”.

### 3-2. Recording of Set Operations

The methods of recording set operations can be roughly classified into two types. One (Recording Method 1) involves dividing classes into logic products and logic sums using the expressions (6) and (7), and reconstructing the classes according to certain rules. As represented by the following expression,

∪ⱼ₌₁ⁿ(∪ᵢ₌₁^{m}Cᵢ)ⱼ

classes combined with one another by logic products are put together in a list of each constituent component (in the expression (6), in the set of jth logic product formulas put in the brackets, m classes are combined with logic product), and the logic sums having the set of joined classes as a term are enumerated. In the expression (6), j is determined and treated as one unit, and the number (n) is indicated by the list of logic sums, so that the Boolean algebras consisting of products and sums can be recorded in a certain format.

The other method (Recording Method 2) involves recording operations in the form of a tree having classes as leaves, with the inter-class logic operations being the upper nodes, as shown in FIG. 8. The logic operation tree shown in FIG. 8 is equivalent to

((C_{1∩C}₂)∪C₃)∩(C₃C₄) (9)

The contents data (instances) are not necessarily input to all the classes described in the dictionary. Accordingly, the above described two recording methods involving inter-class logic formulas can eliminate the trouble and time of producing a detailed dictionary in which the property inheritance relation and the property importing relation among classes are described in advance, in comparison with the conventional technique where the property inheritance relation and the importing relation among classes are described in advance. Users do not need to grasp the specific rules and methods relating to the descriptions of inheritance and the property import. In addition, the amount of description concerning the property import in the data dictionary can be reduced.

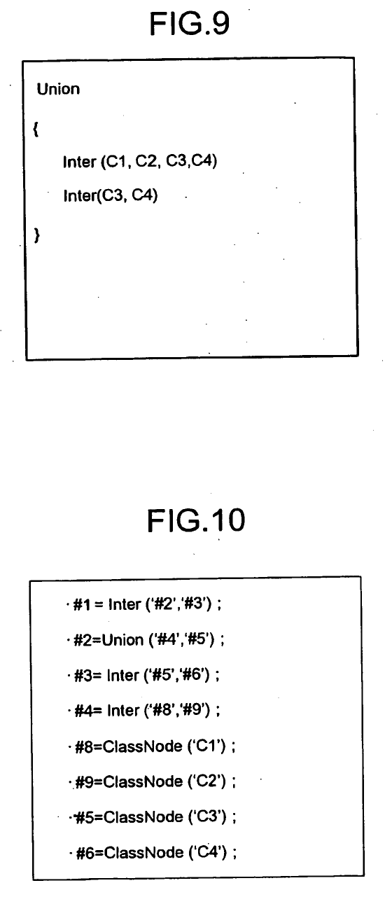

FIG. 9 shows an exemplary description in the inter-class logic operation file 18 according to Recording Method 1. The logical relations among the classes C1, C2, C3, and C4 shown in FIG. 8 are described in such a manner as to satisfy the requirement defined in the expression (8). Here, attention should be paid to the fact that the product of C3 and C3 is C3. The operation to be performed by the logic formula evaluating unit 12 involves converting the information of the inter-class formula tree defined directly by the expression (9) into the format of the expression (8). This can be done by transforming the formula, using the relational expressions of (6-1) and (7).

FIG. 10 shows an exemplary description in the inter-class logic operation file 18 according to the Recording Method 2. The logical relation among the classes C1, C2, C3, and C4 shown in FIG. 8 is broken down and directly described as the data representing the inter-class operator tree. In the file, a symbol consisting of “#” and a numeral represents a term of a formula or a sentence number in the list. For example, the formula represented by “#1”, is the product of “#2” and “#3”, the formula represented by “#2” is the sum of “#4” and “#5”, and the formula represented by “#3” is the product of “#5” and “#6”. Accordingly, the sentence numbers (or the term numbers) contained in the right-hand side of each formula are tracked so as to track down all the terms below the inter-class operator tree.

### 4. Editing of Logic Operation File 18 by Logic Formula Editor Unit 15

The editing of the logic operation file 18 by the logic formula editor unit 15 is now described in detail. As mentioned earlier, using the inter-class logic operation file 18 which serves as a text, or utilizing the GUI, the logic formula editor unit 15 generates a new class, a derivative property, and a new identifier (Basic Semantic Unit (BSU)) through product operations.

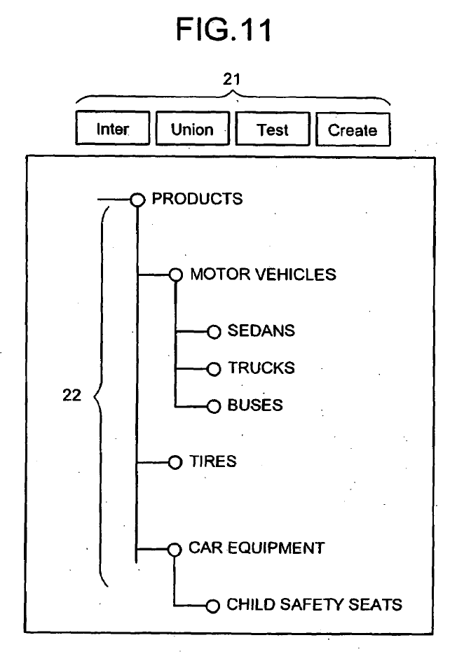

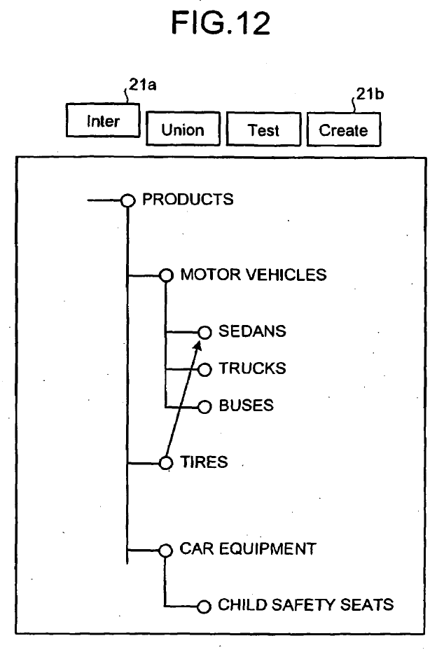

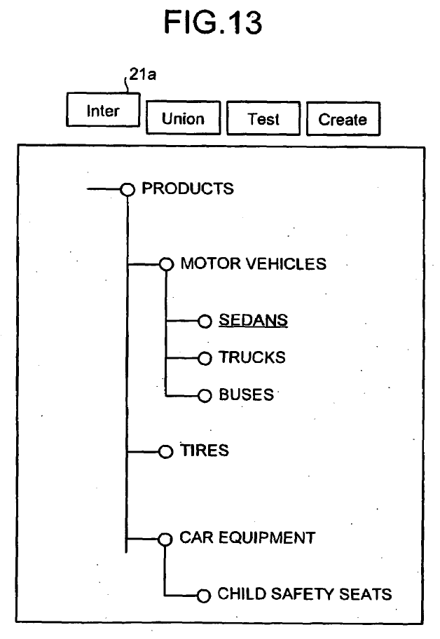

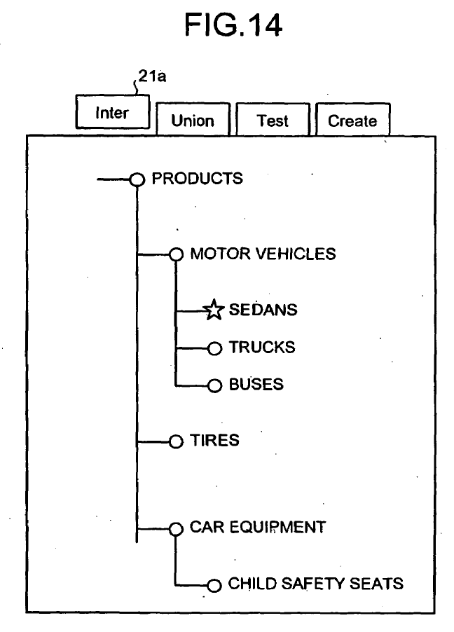

FIG. 11 shows an example of an actual GUI for allowing the user to give an instruction on an inter-class Boolean operation. A reference numeral 21 indicates buttons provided for the user to give an instruction on an inter-class product or sum operation, and a reference numeral 22 indicates an example of a class diagram. FIG. 12 shows an example of the actual GUI for generating an operation result as a lower class of one operator. In FIG. 12, an Inter (product operation) button 21a is first selected, so as to designate the tire class. Next, the sedan class is selected. As a result, the arrow from the tire class to the sedan class is drawn in the class diagram. To actually create a class below the sedan class after the operation, a “Create” (generation) button 21b is selected. In FIG. 12, the color of the button is the same as the color of the arrow. Alternatively, the characters may be shown in the same color as the button, or a symbol is added in the same color as the button. Alternatively, as shown in FIG. 13, the operand class may be highlighted shown by bold characters or a shade or a mark. The class (the import destination) to actually generate a subclass may be distinguished from the other classes by an underline or a different symbol from the other symbols as shown in FIG. 14.

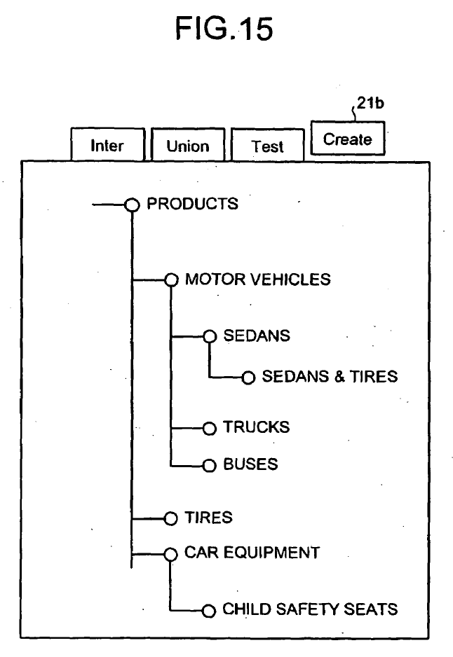

FIG. 15 shows an example where the method shown in FIG. 12 is utilized, in which instruction is given so that a product operation between the sedan class and the tire class is performed, and the result is created under the sedan class. In FIG. 15, the class “sedans & tires” is automatically created under the sedan class. The name of the class to be automatically created may be “sedans and tires” or “sedans*tires”, for example. The GUI may be prepared so that the creator of the class can input to set or change the name.

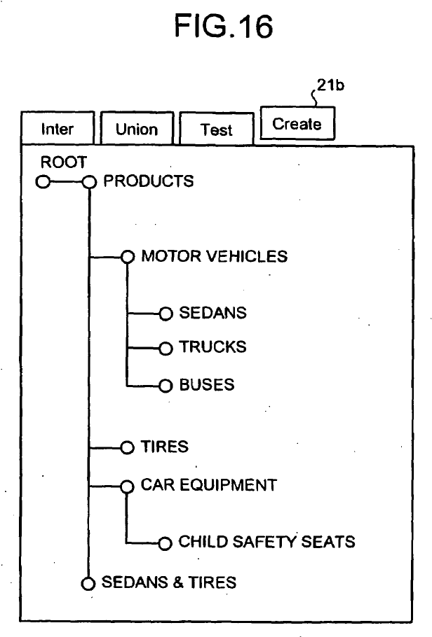

FIG. 16 shows an example where a composite class is created as an “application class” directly below the root, instead of under one of the classes. The “application class” is created separately from the other classes, as described above. It is of course possible to design the structure so that a user may select whether to create the “application class” under the operand class or below the root every time an operation is performed or in advance.

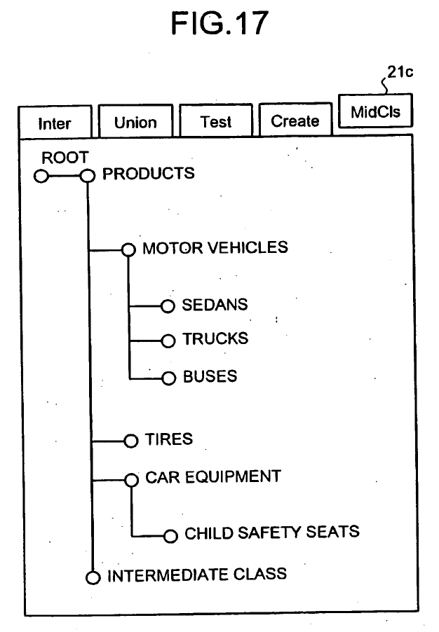

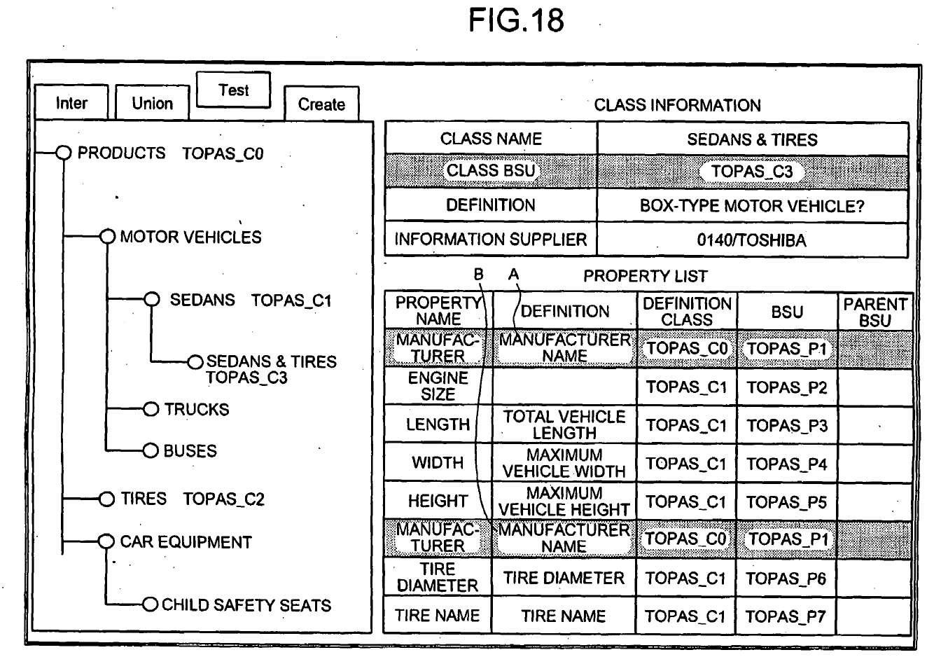

FIG. 17 shows an example where an intermediate class is created below the root. The intermediate class is a class created by collecting all or part of the properties from one or more classes in the existing dictionary. By selecting a button (MidCls) 21c for creating an intermediate class, an intermediate class is created independently of the existing classes. This class is used as a palette for combining properties. For example, in a GUI structure shown in FIG. 18, when a class is selected, the list of properties belonging to the selected class is displayed. A property to be imported is then selected from the property list. This import can introduce each property from the outside of a parent class by a regular method called “Case of” in the case of the PLIB standard. If the multiple inheritance is allowed, all the properties may be imported from parent classes to the intermediate class. Thus, the function of the intermediate class creating unit is carried out.

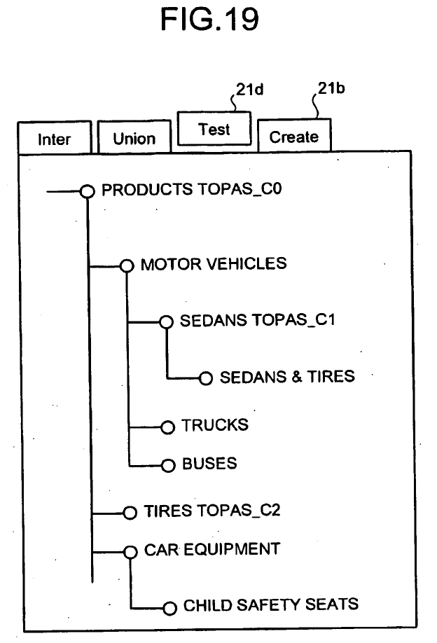

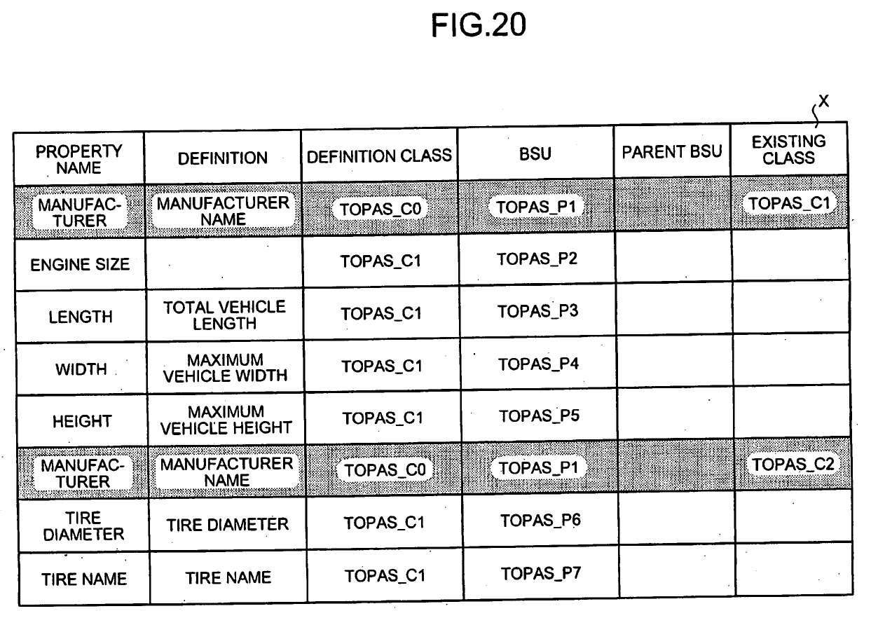

FIG. 19 shows an example where a combined state as a result of an operation is displayed. In the example shown in FIG. 19, a temporary evaluation button (Test) 21d is provided, independently of a button for saving operation results in a database or a file. In a case where properties having the same identifier are contained in the operand classes as shown in FIG. 20, a mark to indicate that there are duplicating properties is displayed in the combined class with the use of the “Test” button 21d, instead of the “Create” button 21b. In FIG. 20, for example, the color of the background is changed so as to mark the duplicating properties, which are a property A of “manufacturer” under the sedan class (class BSU: TOPAS_C1) and a property B of “manufacturer” under the tire class (class BSU: TOPAS_C2), both having the same BSU, “TOPAS_P1.” The two properties have the same definition, .but the color of the background of the existing class names or the BSU of the existing classes (the column X in the property list in FIG. 20) or the classes may be changed so as to clearly indicate to which operand class each of the two properties belongs.

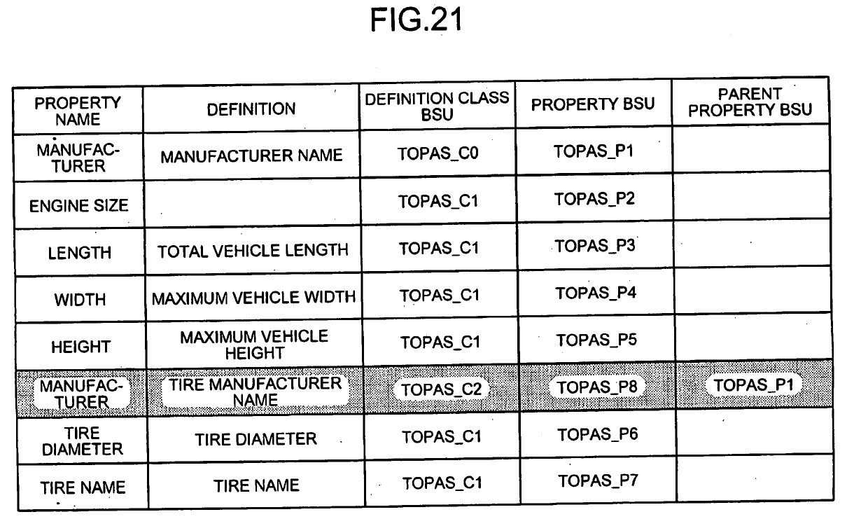

FIG. 21 shows an example where the definition of the property B of the detected duplicating properties is changed. More specifically, the definition of the property is limited to “tire manufacturer”, and the definition class is changed to “tires (TOPAS_C2)”. Then, “TOPAS_P8” is input as a new property BSU. The new BSU may be automatically generated so as not to cause a duplication in the system. After the property BSU is changed, a parent property (super property) can be automatically set to the value of the property BSU before the change of the property definition.

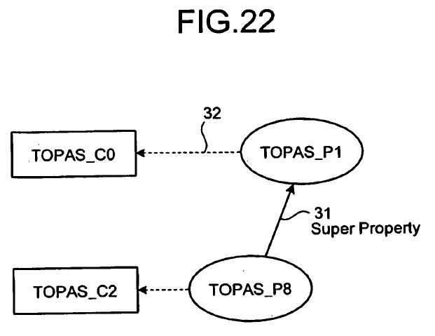

FIG. 22 shows an example of the relation between a derivative property and a parent property (super property) shown in FIG. 21. The derivative property has a field 31 called “Super Property”. The BSU of the parent property is written in the field 31, so as to associate the parent property and the derivative property with each other. A reference numeral 32 in FIG. 22 indicates a field of the definition class of the property.

More specifically, instead of recording a new property and its original property or information on those properties equally associated with each other by mapping or the like in a database or a file, a parent property (super property) equivalent to an higher concept of those properties is defined, and a conjugate property is defined as a derivative property which is a special form of the parent property (super property). The parent property and the conjugate property are then both recorded. By doing so, with the name and the identifier of the parent property (super property) serving as the base, the function of handling derivative properties as the same properties can be achieved. At the same time, with the name and the identifier of each of the original properties serving as the base, the function of handling the derivative properties as different properties can be realized.

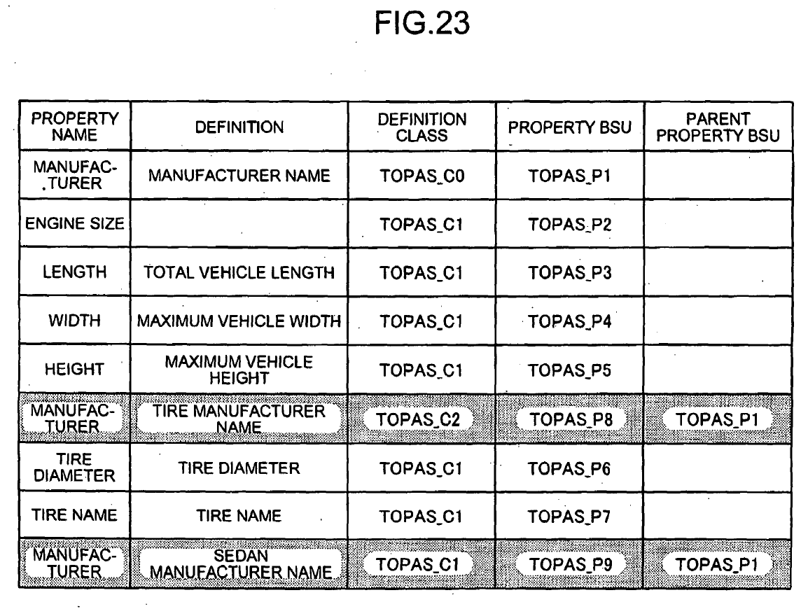

FIG. 23 shows an example where the property definition of the property B of the duplicating properties is changed at the same time as the change of the property A. More specifically, the definition of one of the duplicating properties is limited to “sedan manufacturer”. The definition class of the property is changed to “sedans (TOPAS_C1)”, and “TOPAS_P9” is input as a new property BSU. Meanwhile, the other duplicating property is limited to “tire manufacturer”. The definition class of the property is changed to “tires (TOPAS_C2)”, and “TOPAS_P8” is input as a new property BSU. Since the original property remains as “TOPAS_P1” under the “sedans & tires” class, the relational expression between the properties is maintained before and after the product operation.

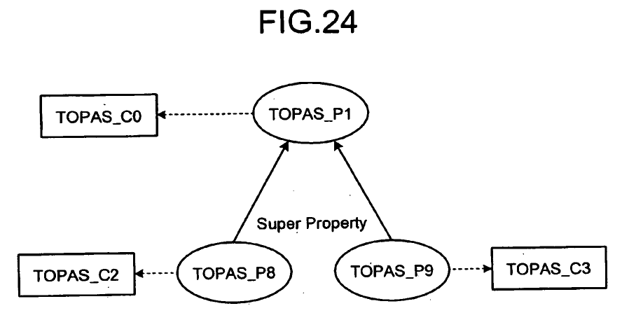

FIG. 24 shows an example of the relation between the derivative properties and the parent property (super property) shown in FIG. 23. In FIG. 23, two properties are generated as derivative properties. The identifier (property BSU) of each new property is generated as the specialization of the original property, and the derivative relations with the original properties are stored basically by the method shown in FIG. 9 or 10.

When properties having the same identifiers generated through inheritance or import of one property are to be identified, the probability of a duplication of those properties is automatically or semiautomatically detected and is then presented visually to users in a distinguished manner through GUI, to prompt the user to confirm the derivation of properties. New identifiers generated through the property derivation can be automatically or semiautomatically set, and the relation between the original properties and the derivative properties is recorded. Thus, the derivative properties can be treated as the same properties. In addition, the derivative properties can be treated as different properties, based on the name and the identifier of each of the original properties. According to ISO13584 standard, the difference between the two properties can be determined by the difference determined by the following expression in which identifiers are joined to one another:

Information_supplier_identifier.Class_identifier.Property_identifier (10)

However, the class identifier described above is the identifier of a class having an originally defined property, and is different from the identifier of a class actually having exported its property or the identifier of a class actually having imported a property according to the present invention.

As described above, in this embodiment, a property to be introduced from an existing class to a new class is determined through a logic operation between classes described in the logic operation file, and the determined property is converted into a hierarchical dictionary data model to be output as a hierarchical dictionary file in a predetermined format. Accordingly, inheritance or “Case of” import of all properties is not necessary in practice. Instead, only the relation between classes is described with operators, and instances are actually created. Here, only the class to which an actual data value is to be input in accordance with the property needs to be converted into a complete hierarchical dictionary file. Accordingly, the trouble and the time of creating a detailed dictionary in which the property inheritance relations and import relations among classes are described can be eliminated, unlike with the conventional method in which the property inheritances and imports among classes need to be described in advance. Users do not need to grasp the specific rules and methods relating to the description of the inheritances and the imports of the properties, and the amount of descriptions as to property imports in the dictionary can be reduced. Thus, the dictionary file can be simplified, and the computing time required for combining data at the time of dictionary creation can be shortened.

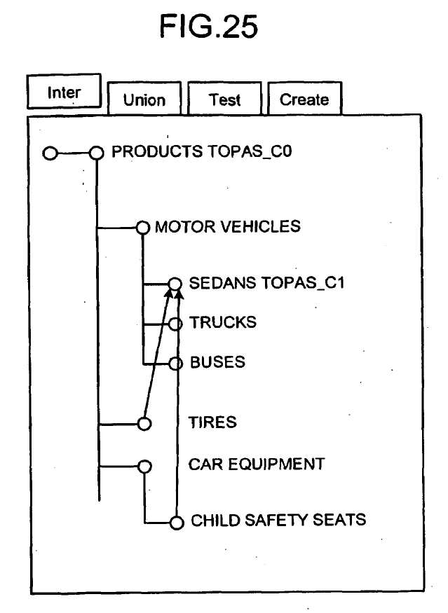

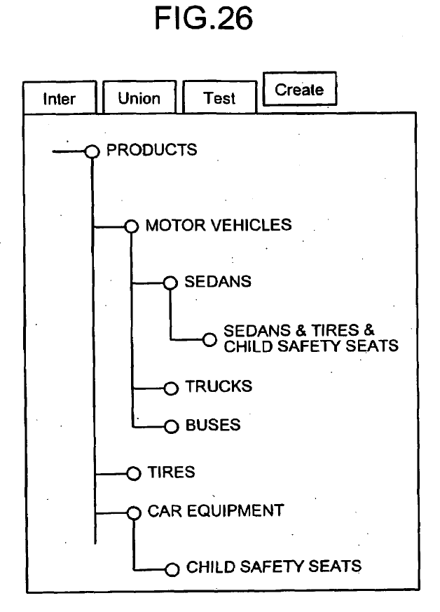

FIG. 25 shows an example of the GUI in which a new class is generated through a product set operation among three classes, instead of a product set operation between two classes. FIG. 26 shows an example of the result of the new class generation. It is also possible to create a post-operation class under the root class, as shown in FIG. 16.

It is of course possible to convert the inter-class set operation tree created as described above into an actual inheritance relation or “Case of (partial inheritance)” relation to be output at any time.

Next, a second embodiment of the present invention is described. The same components as those of the first embodiment are denoted by the same reference numerals as those used in the first embodiment, and explanation of them is not repeated.

In the first embodiment, when the duplicating properties are detected, a super property equivalent to a higher concept of the properties is defined. In the second embodiment, on the other hand, when two or more properties having the same identifiers exist in existing classes in an existing dictionary, and the range of the actual values of the properties is limited or restricted to a narrower range than the value range of the properties in the original definitions by information supplied from the outside or an analysis of the structural, semantic, or actual value range, other identifiers are automatically given to the properties to be imported from the existing classes, or are given to the properties in accordance with an instruction from a user, so that the properties can be distinguished from one another.

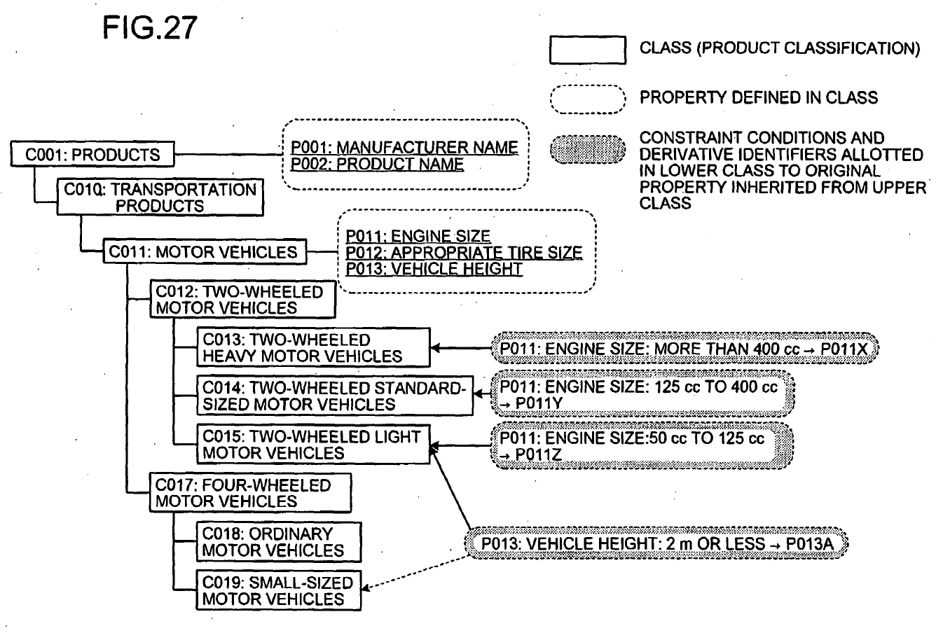

FIG. 27 shows an example of a hierarchical structure according to the second embodiment. In FIG. 27, the solid-line boxes indicate classes, and the broken-line ovals indicate property groups that are defined by the classes. The shaded broken-line ovals indicate the constraint conditions that are given at lower classes in relation to the properties inherited from upper classes. Each of the classes and properties has an identifier as well as a name. An identifier guarantees the uniqueness of the class or the property at least in the hierarchical structure. Examples of hierarchical databases that can be employed in the present invention include ISO13584/IEC61360. In such databases, the identifiers of the classes and the properties are described in the internationally unique BSU (Basic Semantic Unit) codes.

In FIG. 27, the identifier of the property “P001: Manufacturer Name” is “P001”, and the name is “Manufacturer Name”, for instance.

As for the relation among classes, the class “C010: Transportation Products” is a lower class of the class “C001: Products”, and inherits the properties “P001: Manufacturer Name” and “P002; Product Name” defined in the class “C001: Products”. These properties are also inherited by the class “C011: Motor Vehicles” which is the lower class of “C010: Transportation Products.” Since the class “C011: Motor Vehicles” has the self-defined properties “P011: Engine Size”, “P012: Suitable Tire Size”, and “P013: Vehicle Height”, the properties that can be used in the class “C011: Motor Vehicles” are the five properties P001, P002, P011, P012, and P013, including those inherited.

The class “C012: Two-Wheeled Motor Vehicles” has three lower classes “C013: Two-Wheeled Heavy Motor Vehicles”, “C014: Two-Wheeled Standard-Sized Motor Vehicles”, and “C015: Two-Wheeled Light Motor Vehicles”. For these three classes, there are constraint conditions as to the property “P011: Engine Size” inherited from the class “C011: Motor Vehicles”. Normally, the properties may be handled with the same identifiers, even if the constraint conditions are different from one another. In the second embodiment, however, different identifiers (derivative identifiers) not duplicating one another in the hierarchical structure are automatically allotted to the properties having the constraint conditions at the time of input to the database of the hierarchical structure. Users may be allowed to set the range (classes) and the timing of allotting derivative identifiers.

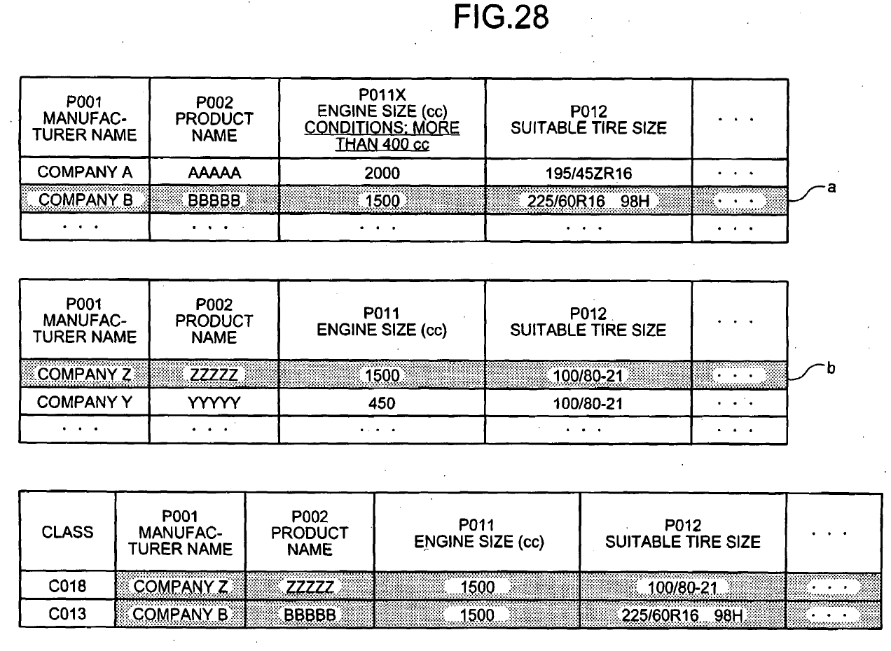

In the second embodiment, derivative identifiers are allotted to all the three properties having constraint conditions. As shown in FIG. 27, the property “P011: Engine Size” is handled as “P011X: Engine Size” with a new derivative identifier “P011X” in the class “C013: Two-Wheeled Heavy Motor Vehicles”, as “P011Y: Engine Size” with a new derivative identifier “P011Y” in the class “C014: Two-Wheeled Standard-Sized Motor Vehicles”, and as “P011Z: Engine Size” with a new derivative identifier “P011Z” in the class “C015: Two-Wheeled Light Motor Vehicles”. Although having a derivative identifier allotted due to the constraints, each of the properties is handled as the property “P011: Engine Size” under normal conditions. For example, when a search is carried out on the classes lower than the class “C011: Motor Vehicles” on the condition that “P011” is 1500 cc, the content “a” which is “P011X=1500(cc)” is selected from the second row in the content table of the class “C013: Two-Wheeled Heavy Motor Vehicles”, and the content “b” which is “P011=1500(cc)” is selected from the first row in the content table of the class “C018: Ordinary Motor Vehicles”, as in the example shown in FIG. 28. The leftmost-side column in the search result table in FIG. 28 shows the classes to which the search results originally belong.

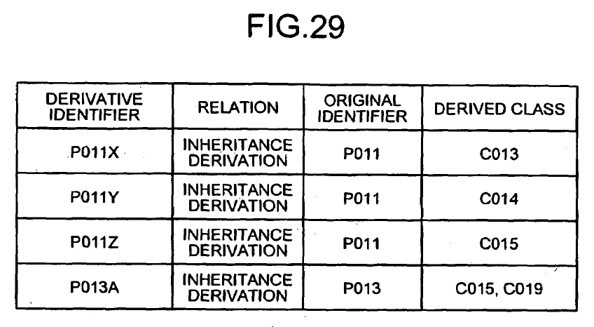

FIG. 29 shows an exemplary description of the relation between original identifiers and derivative identifiers in a database (or a file). The described relation in the database (or the file) can be referred to and be treated as the same properties at the time of search. Likewise, when the search is carried out on the classes below the class “C011: Motor Vehicles” on the condition that “P011X” is 1500 cc, using the relation shown in FIG. 29, the search result shown in FIG. 28 may be obtained.

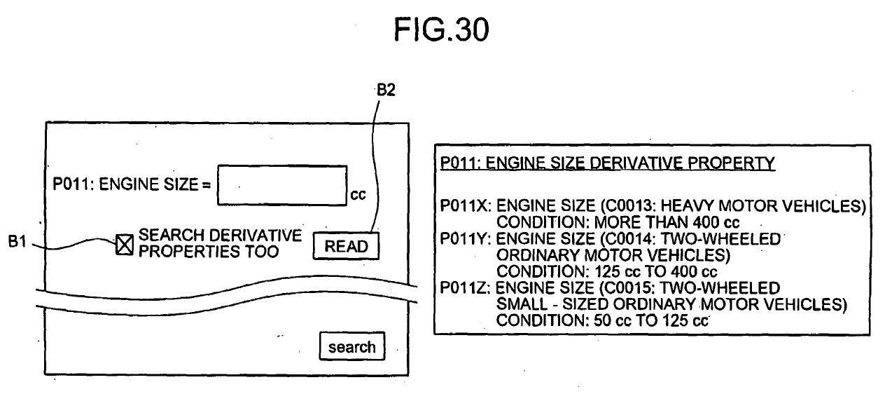

FIG. 30 is an exemplary display on the search condition setting screen for the class “C012: Two-Wheeled Motor Vehicles”. The property “P011: Engine Size” remains as it is in the defined class, but has a different derivative identifier in each lower class with conditions. The information of the derivative identifiers is displayed together with the properties on the search screen for the class “C012: Two-Wheeled Motor Vehicles”. By doing so, the properties with the different identifiers can be searched for, and can be clearly distinguished from one another.

In FIG. 30, the derivative properties can be searched for by switching on and off a check button B1. Also, when a “read” button B2 is pressed, another window opens, and users can read the information as to the derivative properties.

Although whether the derivative properties are to be searched for is determined collectively in this example, it is also possible to make a decision on each of the derivative properties separately. Further, on any screen displaying the classes having the derivative properties or the derivative properties, instead of the search condition setting screen, the corresponding properties should be indicated with tools such as pop-ups or balloons.

Next, a third embodiment of the present invention is described. The same components as those of the first embodiment are denoted by the same reference numerals as those used in the first embodiment, and explanation of them is not repeated.

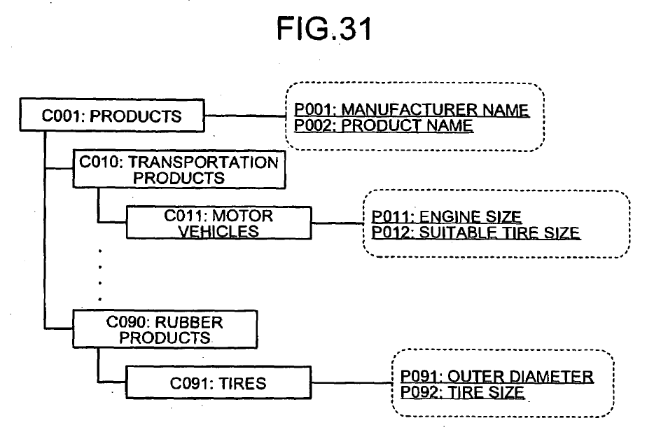

FIG. 31 shows an example of a hierarchical structure according to the third embodiment. In FIG. 31, the solid-line boxes indicate classes, and the broken-line ovals indicate property groups that are defined by the classes. Each of the classes and properties has an identifier as well as a name. An identifier guarantees the uniqueness of the class or the property at least in the hierarchical structure.

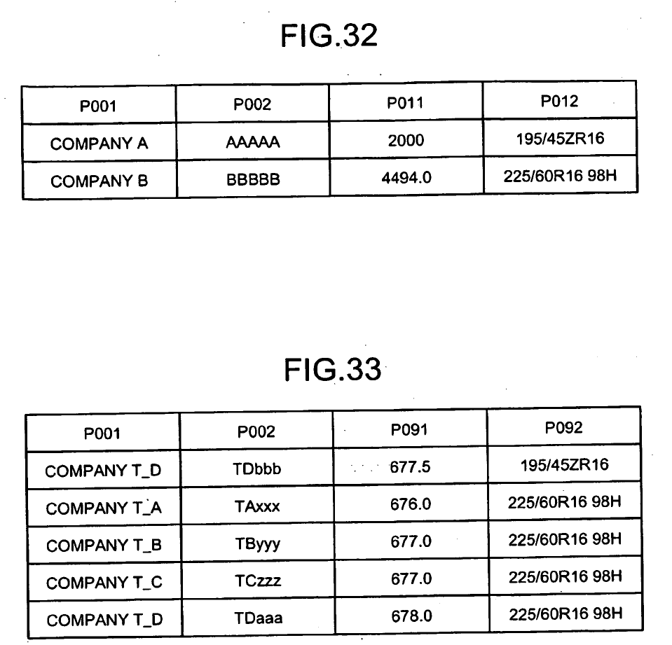

FIG. 32 shows an example of the content table of the class “C011: Motor Vehicles”, and FIG. 33 shows an example of the content table of the class “C091: Tires”. Each content table includes product data rows that show the values of the properties that can be used in the class. Each content table has the same structure as the relational database table, and operations can be performed between tables.

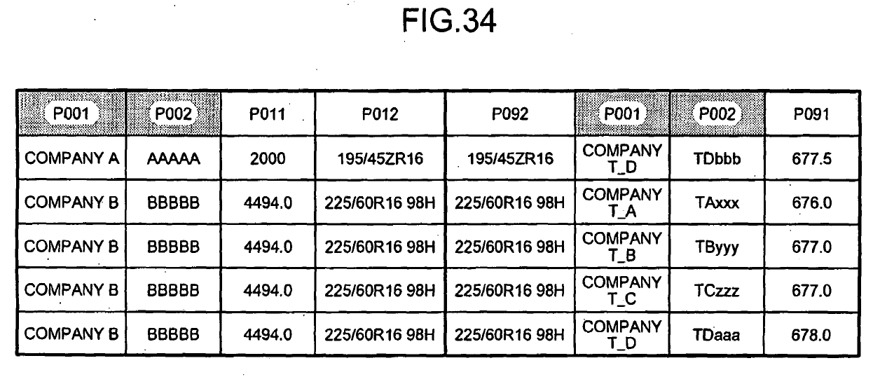

FIG. 34 shows an example of the result of Join operations between the content tables of FIGS. 32 and 33. FIG. 34 shows the result of

select * from T01, T02 where T01.P012=T01.P092 (SQL)

where T01 represents the content table of FIG. 32 and T02 represents the content table of FIG. 33.

In a regular relational database, the column name of each schema is closed in the table. Even if a schema having the same column name exists in another table, the equivalence of the schema columns having the same name is not guaranteed between the tables. Other than the name, each schema column has information such as the data type including units. In a hierarchical database according to the present invention, the property corresponding to a schema column defines various kinds of information, such as the codes internationally uniquely representing the properties, the definition, the definition source, and remarks, other than the name and the data type. Since the property is uniquely identified, the same property codes guarantee the same properties between different tables. If there are two schemas having the same column name in the result of an operation, one or both of the column names are changed, so as to form tables without a duplication.

However, if the properties of the results obtained through operations duplication with each other in a hierarchical database, changing only the property names (or property identifiers) causes the following problems:

1. The fact that the original properties are the same is not guaranteed.

2. To form a content table belonging to a class in a hierarchical structure, it is necessary to define new properties in the hierarchical structure, instead of changing property names.

3. A content table needs to be put in the class having all the properties necessary for a resultant content table.

In the following, the measures to solve these problems are described.

### First Measure

As a first measure to solve the problems, a new class is created as a lower class of one of the classes to which a content table after an operation belongs. For properties duplicating each other, the property appearing from the table of a class other than the parent class is defined as a new property in the new class.

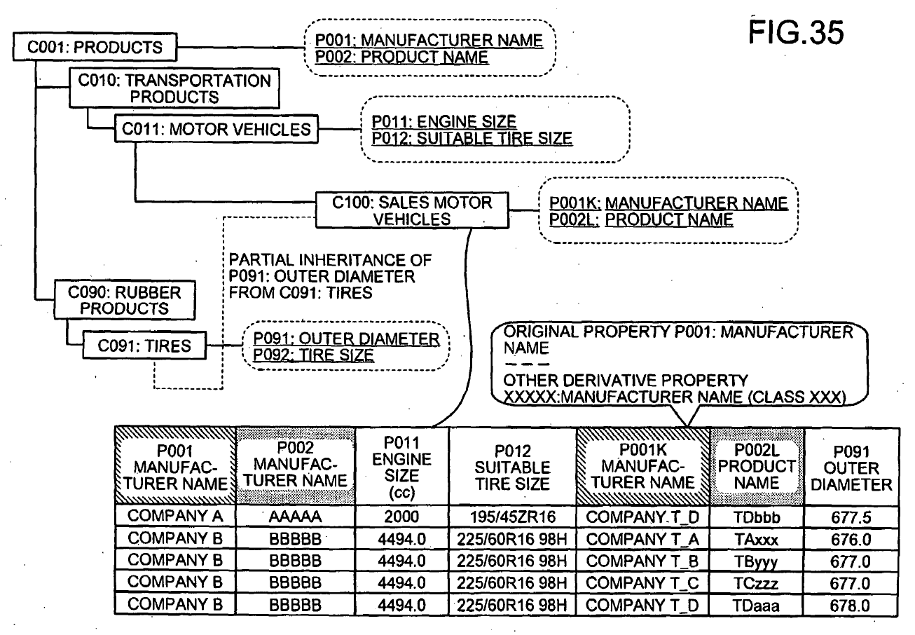

In each of the examples shown in FIGS. 31 to 34, a class “C100: Sales Motor Vehicles” for storing an operation result table is created as a lower class of the class “C011: Motor Vehicles”. The tire inherent property “P091: Outer Diameter” is imported from the class “C091: Tires” to the class “C011: Motor Vehicles”. Also, new properties “P001K: Manufacturer Name” and “P002L: Produce Name” are defined. The operation result is stored in the new class “C100: Sales Motor Vehicles” as shown in FIG. 35. To indicate that the new properties defined in the new class are derived from the existing properties, the information to that effect is shown in the GUI, as shown in FIG. 35. In the example shown in FIG. 35, each derivative property. and its original property are shown in the same background color. When a cursor is placed near the identifier of a derivative property, the information as to the original property and the other derivative properties can be displayed with a pop-up, as shown in FIG. 35.

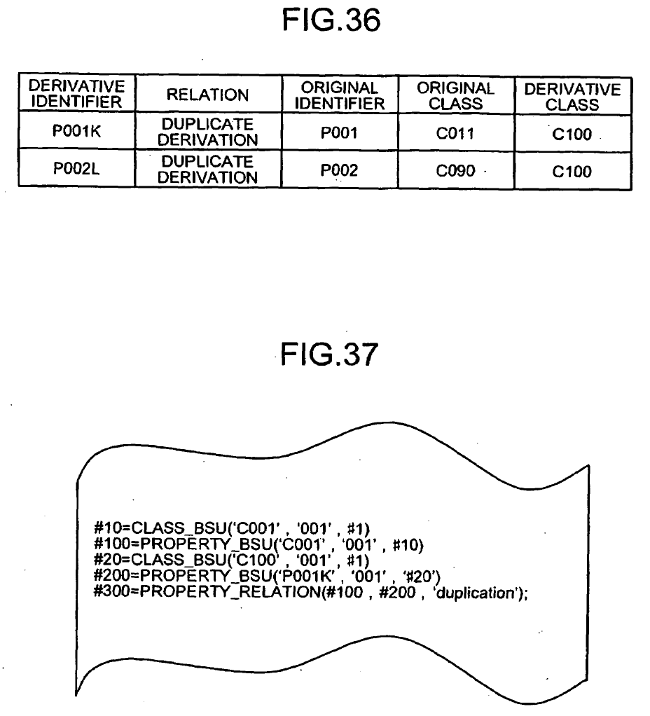

The relation obtained in this case is stored as information in a database (or a file), as shown in FIG. 36. Since the derivative properties are created due to a duplication of properties, it is necessary to include the information of the original classes as the source of the derivative properties.

In this manner, the handling related with the derivative property and its original property can be regarded as the same as those shown in FIG. 29, though there may be small variations in the relation.

FIG. 37 shows an example of a description in which derivative relations are described using the Part 21 format as a data conversion format according to ISO13584, and the derivative relations are formed (described) with EXPRESS. A row starting with #100 represents an original property “POOL: Manufacturer Name”, and a row starting with #200 represents a derivative property “P001K: Manufacturer Name”. The two properties are combined to each other with a row starting with #300, and “duplication” indicates that the two properties duplication each other as a result of an operation.

The relation between the properties represented by the row starting with #300 may be complementarily added by an additional file or the like.

### Second Measure

As a second measure to solve the problems, a new class may be created at a completely different location from both classes that are the operation sources, and new derivative identifiers may be allotted to both of the duplicating properties.

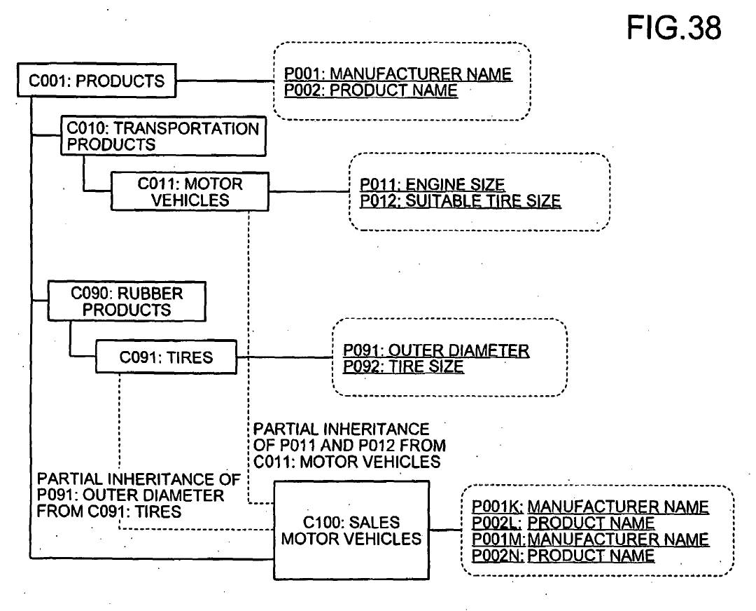

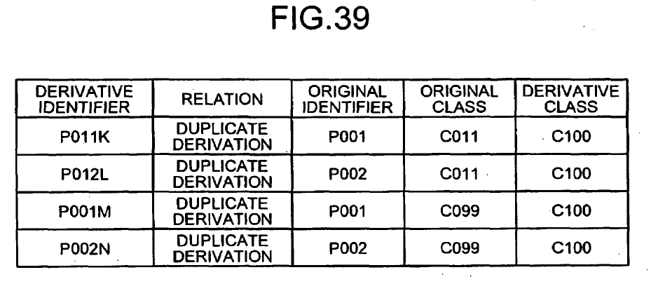

FIG. 38 shows an example of an expanded hierarchy, using the second measure. In this example, four properties “P001K: Manufacturer Name”, “P001M: Manufacturer Name”, “P002L: Product Name”, and “P002N: Product Name” are defined as derivative properties in a new class. Meanwhile, the other properties are imported (partially inherited) from the operation source classes. FIG. 39 shows a database (or a file) that stores the relations in this example.

Additional advantages and modifications will readily occur to those skilled in the art. Therefore, the invention in its broader aspects is not limited to the 5 specific details and representative embodiments shown and described herein. Accordingly, various modifications may be made without departing from the spirit or scope of the general inventive concept as defined by the appended claims and their equivalents.

1. A hierarchical dictionary creating apparatus comprising:
an operation file editing unit that edits a logic operation file by adding a new class using an inter-class logic operation, the logic operation file in which the inter-class logic operation is described, the inter-class logic operation being employed in a hierarchical dictionary having inheritance of a property from an upper class to a lower class;
an operation file storing unit that stores the logic operation file edited by the operation file editing unit;
an operation file determining unit that determines a property to be introduced from an existing class to the new class in the logic operation file stored in the operation file storing unit;
a dictionary file outputting unit that outputs the property to be introduced from the existing class to the new class into a hierarchical dictionary file, the property being determined by the operation file determining unit; and
a dictionary file storing unit that stores the hierarchical dictionary file.

2. The hierarchical dictionary creating apparatus according to claim 1, further comprising a dictionary file inputting unit that reads in the hierarchical dictionary file,
wherein the dictionary file outputting unit combines the hierarchical dictionary file read by the dictionary file inputting unit with the property to be introduced from the existing class to the new class, the property being determined as the result of evaluation by the operation file determining unit, and outputs the combined data as the hierarchical dictionary file.

3. The hierarchical dictionary creating apparatus according to claim 1, wherein
property import defined through the inter-class logic operation involves outputting the hierarchical dictionary file converted into an importing format of each property using “Case of” defined by ISO13584 standard.

4. The hierarchical dictionary creating apparatus according to claim 1, wherein
the dictionary file outputting unit further includes an editing unit that allows editing of the hierarchical dictionary data model based on the property to be introduced from the existing class to the new class on a screen, the property being the result of evaluation by the operation file determining unit.

5. The hierarchical dictionary creating apparatus according to claim 1, further comprising
an intermediate class generating unit that generates an intermediate class containing all or a part of the properties of one or more existing classes, the intermediate class being independent of existing classes,
wherein the operation file determining unit determines a property to be introduced from the intermediate class to a new class.

6. The hierarchical dictionary creating apparatus according to claim 1, wherein the dictionary file outputting unit notifies when an operand of the inter-class logic operation contains properties having an identical identifier.

7. The hierarchical dictionary creating apparatus according to claim 1, wherein
the dictionary file outputting unit defines a derivative property equivalent to a higher concept of a conjugate property when an operand of the inter-class logic operation contains properties having an identical identifier, and associates the derivative property with the conjugate property by treating the conjugate property as a lower property and a specialization of the derivative property.

8. The hierarchical dictionary creating apparatus according to claim 1, wherein
when an operand of the inter-class logic operation contains properties having an identical identifier and has a constraint conditions, the dictionary file outputting unit defines a derivative property to which a derivative identifier is allocated, the derivative identifier being an identifier which is different from the identical identifier of the properties and which does not exist in other location in the hierarchical structure.

9. The hierarchical dictionary creating apparatus according to claim 1, wherein
the dictionary file outputting unit sets a new class as a lower class of one class among classes to which a content table belongs, when the logic operation is performed on the contents tables and properties duplication as a result of the logical operation, the contents tables being formed with data rows having property values with respect to a property that can be used in each class, and, for the duplicating properties, the dictionary file outputting unit defines a property that appears in a content table of a class other than a parent class as a derivative property in the new class.

10. The hierarchical dictionary creating apparatus according to claim 1, wherein
the dictionary file outputting unit sets a new class at a different location from classes to which the logic operation is performed, when the logic operation is performed on the contents tables and properties duplication as a result of the logical operation, the content table being formed with data rows having property values with respect to a property that can be used in each class, and the dictionary file outputting unit defines the duplicating properties as derivative properties by providing a new derivative identifier to the duplicating properties.

11. A computer program product having a computer readable medium including programmed instructions for dictionary creation, wherein the instructions, when executed by a computer, cause the computer to perform:
editing a logic operation file by adding a new class using an inter-class logic operation, the logic operation file in which the inter-class logic operation is described, the inter-class logic operation being employed in a hierarchical dictionary having inheritance of a property from an upper class to a lower class;
storing the edited logic operation file;
determining a property to be introduced from an existing class to the new class in the logic operation file;
converting the property to be introduced from the existing class to the new class into a hierarchical dictionary file, the property being determined; and
storing the hierarchical dictionary file.

12. A method of creating a hierarchical dictionary comprising:
editing a logic operation file by adding a new class using an inter-class logic operation, the logic operation file in which the inter-class logic operation is described, the inter-class logic operation being employed in a hierarchical dictionary having inheritance of a property from an upper class to a lower class;
storing the edited logic operation file;
determining a property to be introduced from an existing class to the new class in the logic operation file;
converting the property to be introduced from the existing class to the new class into a hierarchical dictionary file, the property being determined; and
storing the hierarchical dictionary file.
